(19) United States
(12) Patent Application Publication
(10) Pub. No.: US 2012/0234923 A1
(43) Pub. Date: Sep. 20, 2012

(54) METHOD AND/OR DEVICE FOR MANAGING AUTHENTICATION DATA

(75) Inventor: VIVEKANANDA TAMMA, Naperville, IL (US)

(73) Assignee: VIVEKANANDA TAMMA, CRETE, IL (US)

(21) Appl. No.: 13/156,058

(22) Filed: Jun. 8, 2011

Related U.S. Application Data
(60) Provisional application No. 61/453,908, filed on Mar. 17, 2011.

(30) Foreign Application Priority Data
Mar. 27, 2011 (AU) 2011100338

(51) Int. Cl. G06K 19/073; G06F 21/00

(52) U.S. Cl. 235/492; 726/6

(57) ABSTRACT

The field of invention relates generally to managing authentication data. The authentication management card is a current art standalone credit/smart card sized (100) processing (101) and memory device (102) (103) (104) that is powered by a battery with an extended life (105) with an integrated alphanumeric display (106) and an interface keypad (107) connected to the processor through the Input/Output Interface (108). The operating system on the card (401) verifies access to the authentication management card by a user entered PIN code (402). The application (403) provides the interface to the user to retrieve authentication data on the authentication management card using a PIN challenge. Random strong authentication data is stored either in an encrypted format (405) or in the form of an algorithm (404) on the card and can be retrieved using a PIN challenge.

### BACKGROUND OF THE INVENTION

Authentication data includes, but is not limited to username, password and answer(s) to password reset identity question(s). Authentication data grants access to a website or a secured computer system. In this description of the preferred embodiment username is not included as part of the authentication data, but adding username is a logical extension of the description and is covered by this invention.

With increasing interface to computer devices and use of electronic web pages and online user accounts, the average end user is being overwhelmed with authentication data (passwords and/or password reset identity questions as defined in the previous paragraph). The end user is challenged in using the same authentication data on multiple websites or computer systems, as each website or computer system has different set of rules for authentication. Also, it is not a secure way to have the same authentication data on multiple websites as a compromise of authentication on a single website can result in compromising the confidential and identity information on other websites. The end user might choose to write the authentication information for various websites or computer systems on a paper, but this kind of management has no protection and can be compromised and misused.

It is easy to store the authentication data on a computing device such as an internet server, desktop computer, notebook or a mobile device. However, with the increasing issues of computer viruses and hacking, storing the passwords on a computer machine connected on the network gives an opportunity for the authentication data to be compromised. Managing the password on an isolated computer has the disadvantages of ease of use and portability. Further, an end user is unable to form strong passwords right of their human memory, as the end user thinks they might not remember.

### BRIEF SUMMARY OF THE INVENTION

As discussed in the background of the invention there is a resulting need for a standalone portable computing device and in particular a standard credit card sized secure computing card to manage authentication data.

This authentication management card, the preferred embodiment, can store and/or retrieve authentication data securely. One is using a PIN code to gain access to the card, and second is a PIN challenge to gain access to a unique set of authentication data.

The user will just need to remember a PIN code to gain access to the card and the PIN challenge to get access to a unique set of authentication data to be used on a website or any other authentication system. This is far easier than trying to remember the authentication data set for each website.

The preferred embodiment uses either encrypted authentication data on the card or algorithm with a key to generate strong authentication data and hence eliminate the disadvantages of the user coming up with strong authentication data and trying to remember.

If the preferred embodiment is lost or stolen it is difficult to gain access as it is protected by a PIN code and the preferred embodiment locks itself after unsuccessful retires to get access. Once lost or stolen or damaged, the user can request the manufacturer for a duplicate. The user can also request a new card along with the duplicate if they are concerned about someone imitating their card.

Thus the authentication management card, the preferred embodiment takes care of the disadvantages by solving the issues of
(a) Generating and using strong authentication data
(b) Remembering strong authentication data
(c) Portable, easily available authentication data
(d) Secured authentication data
(e) Secured backup in case of lost, stolen or damaged source of authentication data.

### BRIEF DESCRIPTION OF THE SEVERAL VIEWS OF THE DRAWING

The invention may be better understood with reference to the illustrations of the preferred embodiment (authentication management card) of the invention which:—

FIG. 1 shows the essential hardware components of the preferred embodiment,

FIG. 2 shows the user interface view of the preferred embodiment,

FIG. 3 shows the method of having an algorithm key and its corresponding unique id, PIN code and authentication data that is retrieved with a PIN challenge,

FIG. 4 shows the software components that are on the preferred embodiment,

FIG. 5 shows how to use the preferred embodiment with PIN challenge based on the website name to create authentication data and/or gain access for a website or a computer system,

FIG. 6 shows how to use the preferred embodiment with PIN challenge based on website grouping to create authentication data and/or gain access for a website or a computer system,

FIG. 7 shows how to use the preferred embodiment with a single PIN challenge to create authentication data and/or gain access for a website or a computer system,

FIG. 8 shows how to use the preferred embodiment with PIN challenge based on the first few characters of website name/system (alphabets entered as number similar to telephone keypad) to create authentication data and/or gain access for a website or a computer system,

FIG. 9 shows how the preferred embodiment will reduce the complexity of managing authentication data using options described in FIG. 5 through FIG. 8.

### DETAILED DESCRIPTION OF THE INVENTION

Authentication data generating algorithm uses a key (301) as input to generate passwords (303) and/or password reset identity questions (306). The authentication data and/or the authentication data generating algorithm with key is downloaded onto the authentication management card (200) using existing industry standard protocol. The key used to generate the authentication data is associated with a unique identification (302) which is etched (201) on the authentication management card in order to identify the card. The algorithm key (301) is encrypted on the card and deriving a key from a unique identification (302) will be possible only by the manufacturer.

A power button (204) can be used to logon and logoff from the card that can work in a toggle mode. The stored authentication data and/or algorithm with key are protected by a PIN code (304). The PIN code is encrypted to provide security against any unauthorized access if the authentication management card is lost or stolen. The authentication management card is locked from further access after the maximum number of retries is encountered. The end user uses the keypad (202) (203) to enter the PIN code and gain access to the authentication data or the authentication data generating algorithm.

The end user can retrieve authentication data for display (205) by typing a PIN challenge (305) from their human memory (305) on the keypad (202) and then confirming by pressing OK on the keypad (203). The PIN challenge is easier to remember compared to remembering the actual authentication data.

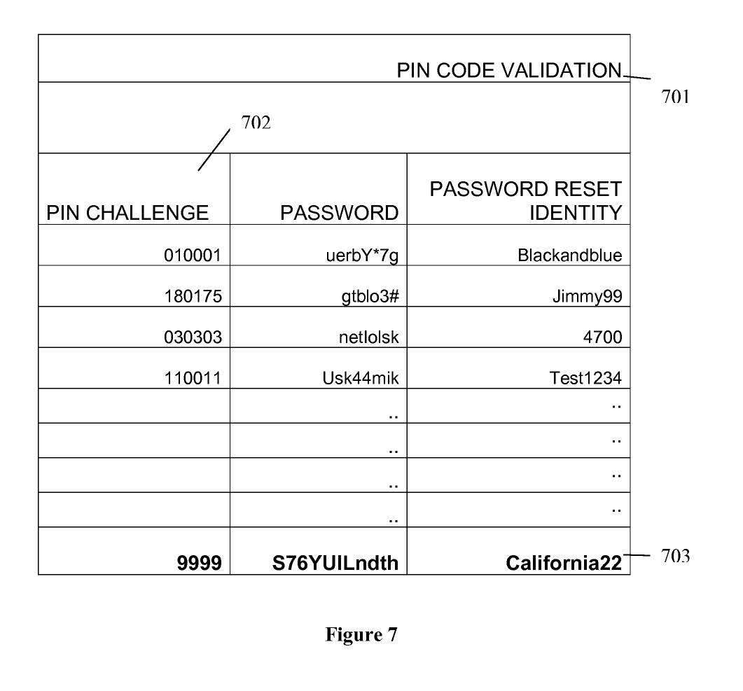

The end user can have the authentication data associated with a single PIN challenge for various websites (FIG. 7). This is a weak link as discussed in the background of the invention, but can be practical for some users. The user first gets access to the authentication management card by entering a PIN code (701). The user then enters the PIN challenge from their human memory (which is a constant number ‘9999’ in this case) (702) on the authentication management key pad to retrieve authentication data onto the display. Once the authentication data is retrieved, the user uses that to gain access to systems or use to create authentication data for a new system or modify authentication data for existing systems (703).

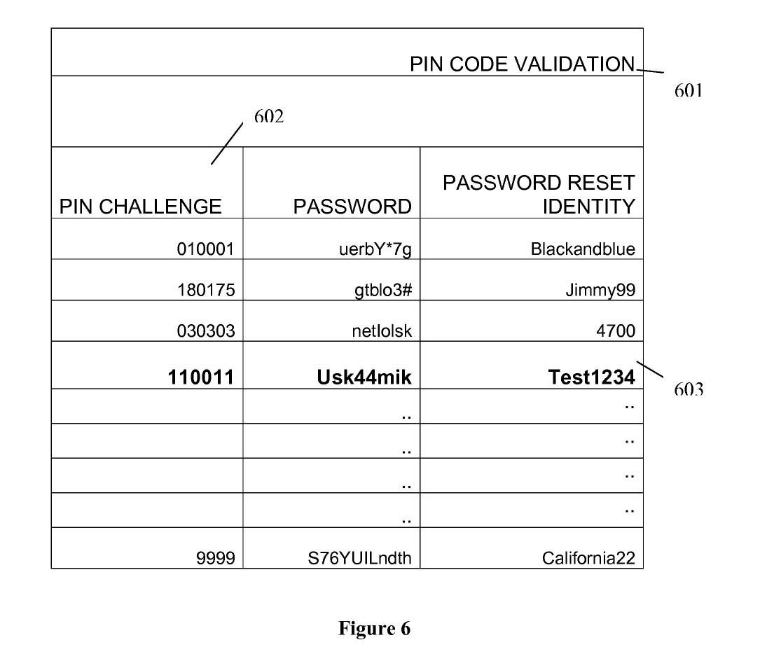

Given multiple online email, banking, health and other accounts the end user can choose to have a single PIN challenge for each group (FIG. 6). The user first gets access to the authentication management card by entering a PIN code (601). The user then enters the PIN challenge from their human memory (which is a challenge for the bank group ‘110011’ in this case) (602) on the authentication management key pad to retrieve authentication data onto the display. Once the authentication data is retrieved, the user uses that to gain access to systems or use to create authentication data for a new system or modify authentication data for existing systems (603).

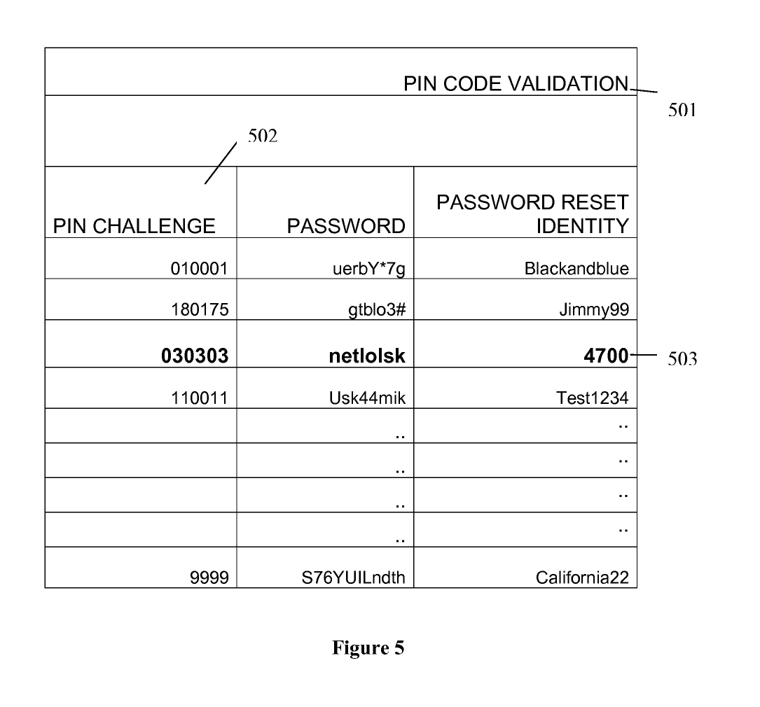

A different rule such as associating the first alphabet of the website with an index (FIG. 5) can also be a secure way. The user first gets access to the authentication management card by entering a PIN code (501). The user then enters the PIN challenge from their human memory (which is a number based on first character of the website name ‘030303’ in case website start with alphabet ‘c’) (502) on the authentication management key pad to retrieve authentication data onto the display. Once the authentication data is retrieved, the user uses that to gain access to systems or use to create authentication data for a new system or modify authentication data for existing systems (503).

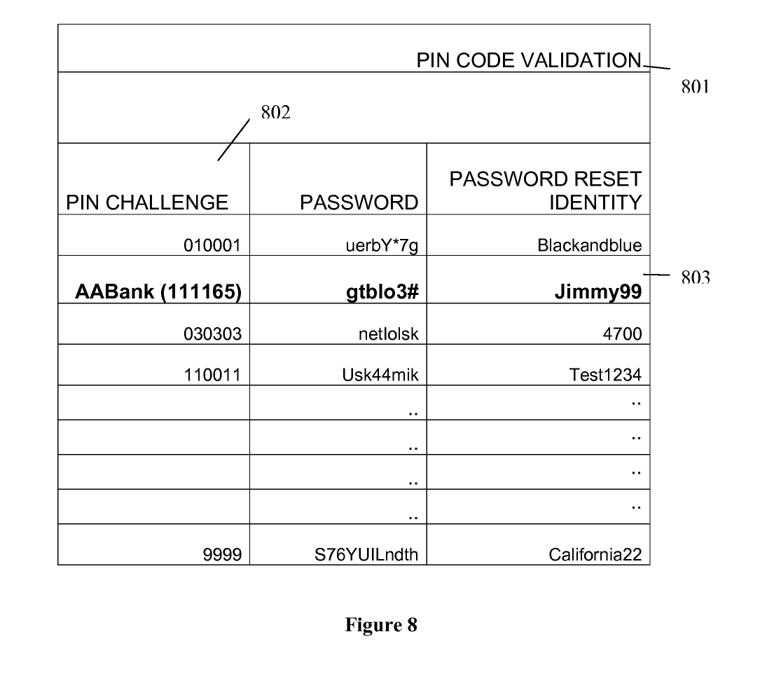

A different method such as entering numbers for website/system name similar to telephone keypad translation (FIG. 8) can also be a secure way. The user first gets access to the authentication management card by entering a PIN code (801). The user then enters some characters of the website name as the PIN challenge from their human memory (which is a number based on the website name ‘111165’ in case website is ‘AABank’) (802) on the authentication management key pad to retrieve authentication data onto the display. Once the authentication data is retrieved, the user uses that to gain access to systems or use to create authentication data for a new system or modify authentication data for existing systems (803).

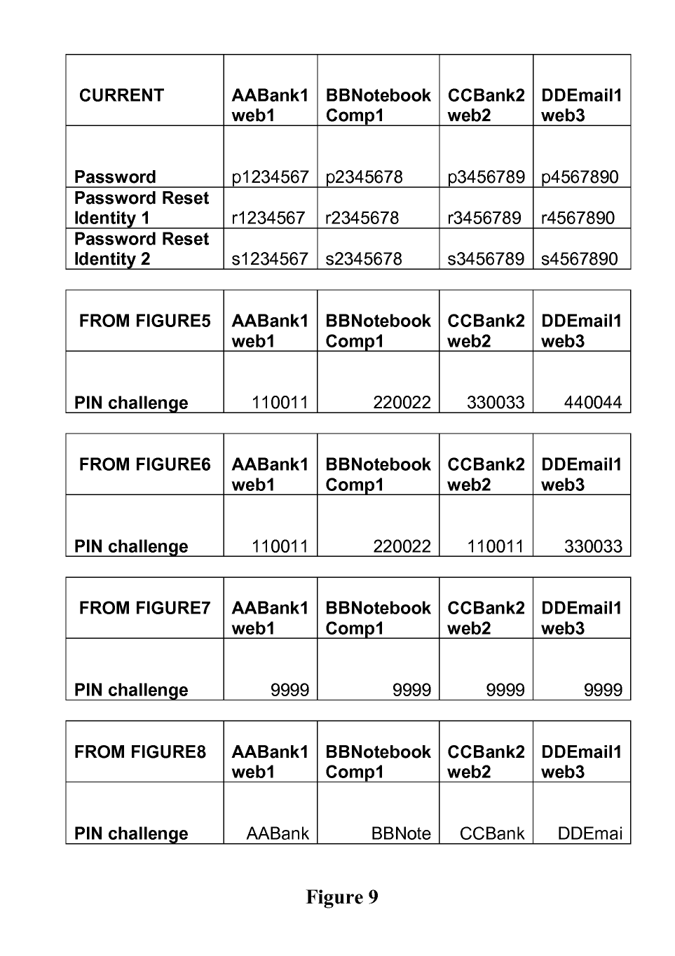

It is up to the end user to use different rules to remember the PIN challenge. Remembering the numeric PIN challenge and associating with a website or system is far easier than remembering multiple authentication data. It reduces the complexity for the end user as shown (FIG. 9). As shown in Option for FIG. 8, all the user has to remember is the PIN code to enter the card and username on various websites and do not have to remember the various passwords and password reset identify questions. Further the end user has strong authentication data at a click when a new or change of authentication data is needed. The strong authentication data is generated by the authentication data generating algorithm. The authentication data generating algorithm on the card

If the authentication data management card is lost or stolen, it is difficult to get into the card by a stranger as it is protected by a PIN code and if the stranger manages to break into the PIN code they are faced with various authentication data which do not really mean anything to a stranger. The authentication data management card manufacturer typically has no user name information to be associated with the authentication data and the legitimate end user is the only one who has access to all the links. If the authentication data management card is lost or stolen, the end user requests for a duplicate card using the Unique ID to regain access to the websites. The end user requests a new Unique ID card to reset all existing authentication data, if the end user thinks that existing authentication data might have been compromised by a lost or stolen authentication data management card. Typically the end user remembers even strong passwords after some usage on a website.

The claims defining the invention are as follows:

1. An authentication data management card device, to manage authentication data such as passwords and password reset identity, comprising an electronic alphanumeric display and having interface keypad with an alphanumeric and/or control and/or power buttons on a credit card size device.

2. An authentication data management card device as claimed in claim 1 that utilizes the industry standard credit card sized smart card with security standards and protected by a PIN code that gives access only to legitimate end users.

3. An authentication data management card device according to any claims 1 and 2 which retrieves unique set of authentication data based on PIN input challenge from the end user human memory.

4. An authentication data management card device according to any of one of the claims 1-3 wherein the end user uses it for gaining access, modifying or creating authentication data for secure websites and/or computer systems.

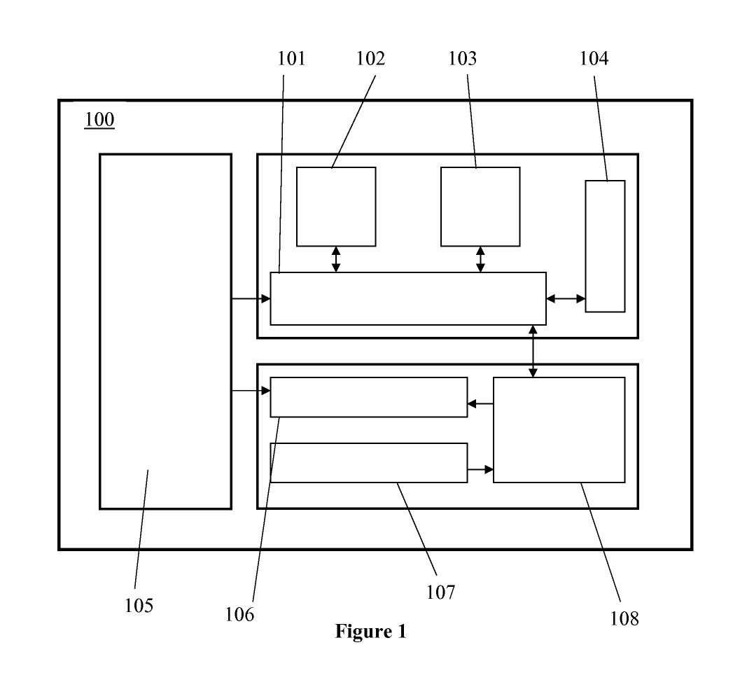

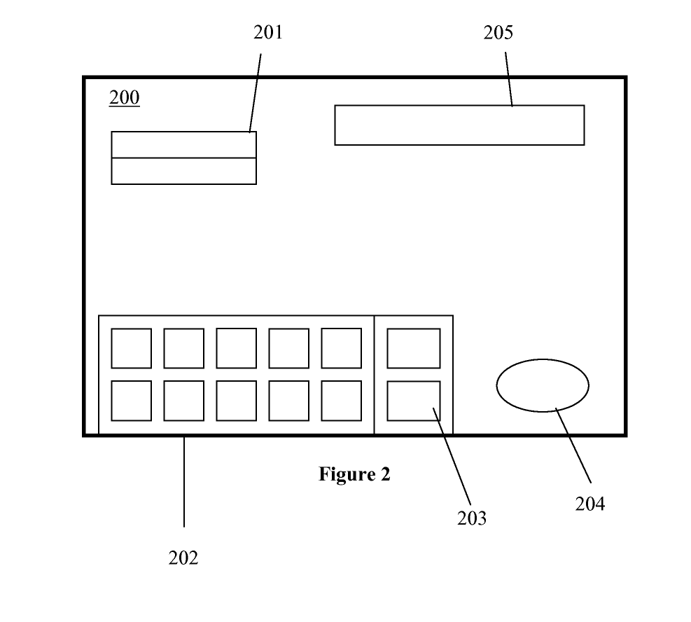

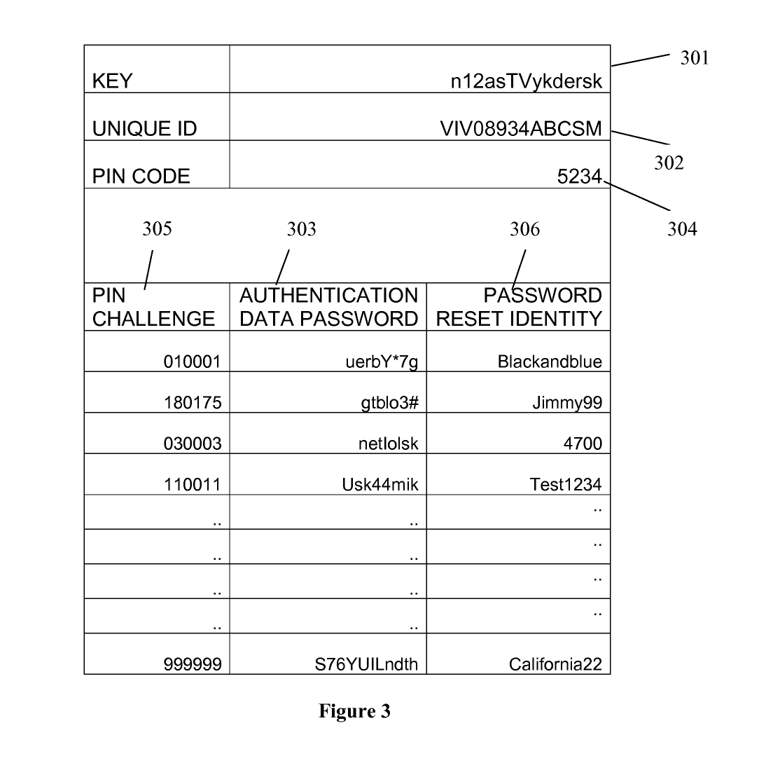

5. An authentication data management card device substantially as herein before described with reference to FIGS. 1-9 of the accompanying drawings.

6. Method of typing alphabets on the numeral keypad of a smart credit card device as described in FIG. 8 and description of FIG. 8 in the specification.

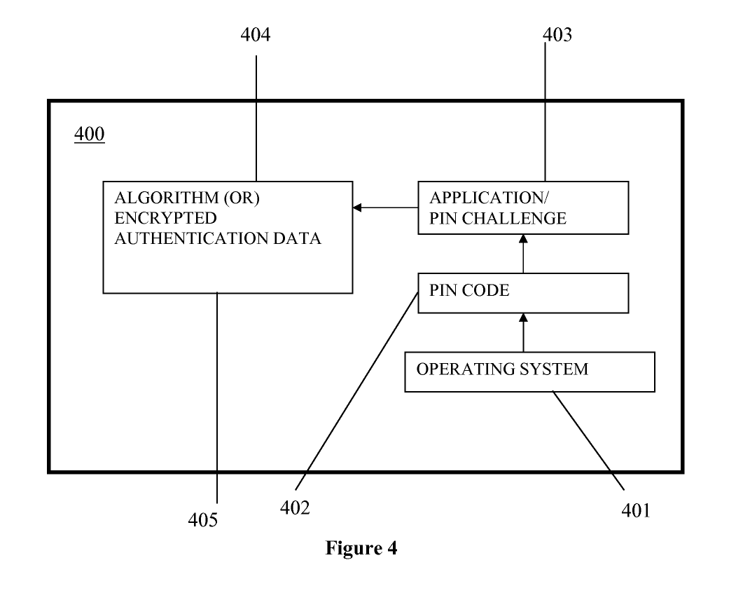

7. Method of using an algorithm with a key to create and retrieve strong authentication data for various authentication systems as described in FIG. 4 and description of FIG. 4 in the specification.
